(19) United States
(12) Patent Application Publication
(10) Pub. No.: US 2017/0368926 A1
(43) Pub. Date: Dec. 28, 2017

(54) ACTUATING DEVICE

(71) Applicant: Tsun-Tien Yao, Taichung (TW)

(72) Inventor: Tsun-Tien Yao, Taichung (TW)

(21) Appl. No.: 15/194,404

(22) Filed: Jun. 27, 2016

(51) Int. Cl. B60K 7/00; B60K 1/02; B60K 17/14

(52) U.S. Cl. CPC B60K 7/0007; B60K 17/14; B60K 1/02; B60K 2007/0092

(57) ABSTRACT

“An actuating device comprises a speed reducer, a fixing member, and a driven member. The speed reducer has an input side, a rotation portion, and an output side. The input side and the output side are respectively arranged at two sides of the rotation portion in an axial direction thereof. The input side or the output side of the speed reducer is fixed at the fixing member. The driven member may be a tire and covered an outer peripheral of the rotation portion. The width of the actuating device becomes thinner and the volume of the actuating device becomes small to make it install to a targeting object (automatic guided vehicle) much easier.”

### FIELD OF THE INVENTION

The present invention relates to an actuating device.

### BACKGROUND OF THE INVENTION

Please refer to FIG. 1, the conventional actuating device 100′ may comprise a speed reducer 1′ and a wheel 2′. The wheel 2′ is coaxially arranged at one side of the speed reducer 1. A motor 3′ is coaxially arranged one side of the speed reducer 1′ opposite to the wheel 2′. Therefore, the motor 3′ drives the speed reducer 1′ to rotate and further control the wheel 2′ to rotate.

However, the width and volume of the conventional actuating device 100′ includes the speed reducer 1′ and the wheel 2′. If it is applied to a targeting object with smaller volume, there is no enough space to receive the actuating device except reducing some elements or sacrificing some functions. It makes the use much narrower.

In view of the foregoing circumstances, the inventor has invested a lot of time to study the relevant knowledge, compare the pros and cons, research and develop related products. After quite many experiments and tests, the “actuating device” of this invention is eventually launched to improve the foregoing shortcomings, to meet the public use.

### SUMMARY OF THE INVENTION

An object of this invention is providing an actuating device, the driven member (such as a tire) is covered outside of the rotation portion of the speed reducer so that the width of the actuating device becomes thinner and the volume of the actuating device becomes small to make it install to a targeting object (such as an automatic guided vehicle) much easier. If the volume of the targeting object is smaller, the actuating device may be easily installed or assembled to match the available space and make the use of the actuating device much broader.

To achieve above objects, an actuating device comprises a speed reducer, having an input side, a rotation portion, and an output side, the input side and the output side are respectively arranged at two sides of the rotation portion in an axial direction thereof; a fixing member, the input side or the output side of the speed reducer is fixed at the fixing member; and a driven member, covered outside of the rotation portion.

In some embodiments, the driven member is a tire.

In some embodiments, the speed reducer is pivoted with a motor for controlling the rotation portion of the speed reducer to rotate.

In some embodiments, the fixing member is arranged at a bottom portion of an automatic guided vehicle.

In some embodiments, a diameter of the rotation portion is larger than a diameter of the input side and a diameter of the output side.

In some embodiments, the driven member is cooperated with a conveyor belt for transmission.

An actuating device comprises a speed reducer, having an input side, a rotation portion, and an output side, the input side and the output side are respectively arranged at two sides of the rotation portion in an axial direction thereof, a diameter of the rotation portion is larger than a diameter of the input side and a diameter of the output side; two fixing members, spaced apart from each other, the input side and the output side of the speed reducer are respectively fixed at the two fixing members; and a driven member, covered outside of the rotation portion.

In some embodiments, the driven member is a tire.

In some embodiments, the speed reducer is pivoted with a motor for controlling the rotation portion of the speed reducer to rotate.

In some embodiments, the fixing member is arranged at a bottom portion of an automatic guided vehicle.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a plan view of a conventional actuating device.

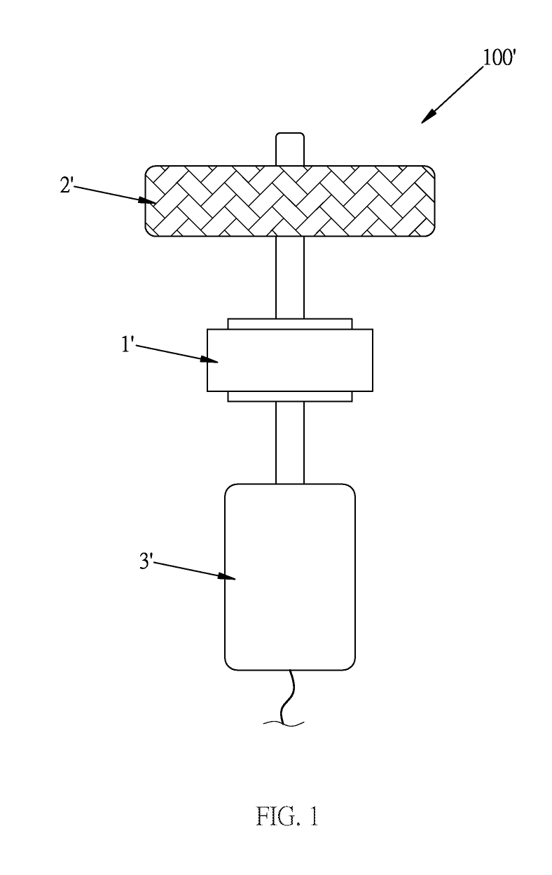

FIG. 2 is an exploded view of an actuating device of the present invention.

FIG. 3 is a perspective view of the actuating device of the present invention.

FIG. 4 is a plan view of the actuating device of the present invention.

FIG. 5 is a view of a first embodiment of the actuating device of the present invention.

FIG. 6 is a view of a second embodiment of the actuating device of the present invention.

FIG. 7 is a view of a third embodiment of the actuating device of the present invention.

FIG. 8 is a view of a fourth embodiment of the actuating device of the present invention.

### DESCRIPTION OF THE PREFERRED EMBODIMENT

Referring now to the drawings where like characteristics and features among the various figures are denoted by like reference characters.

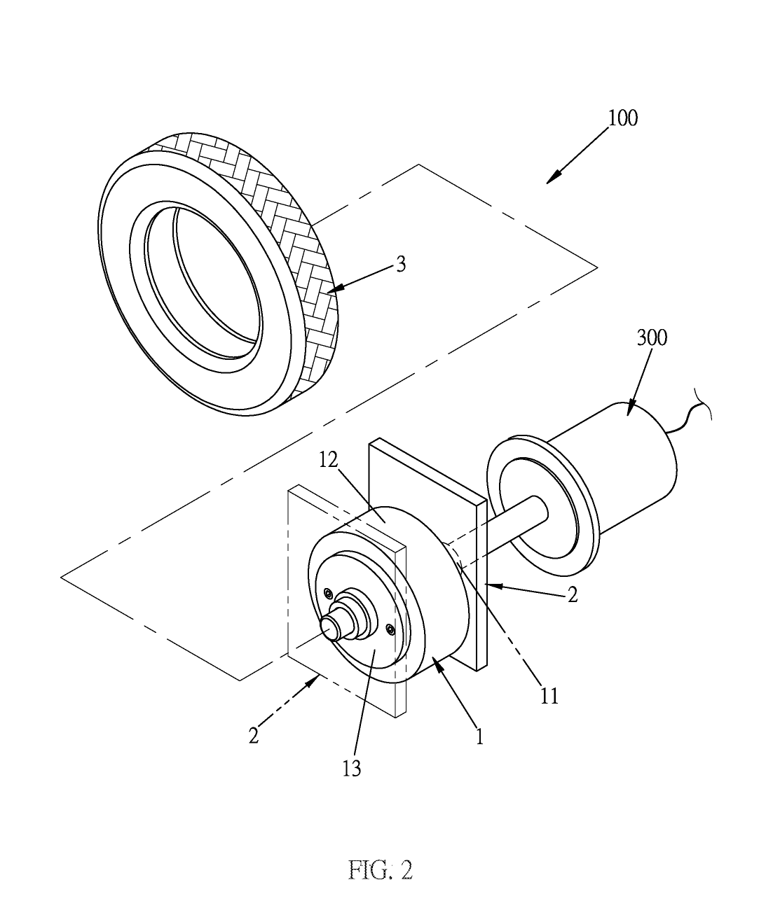

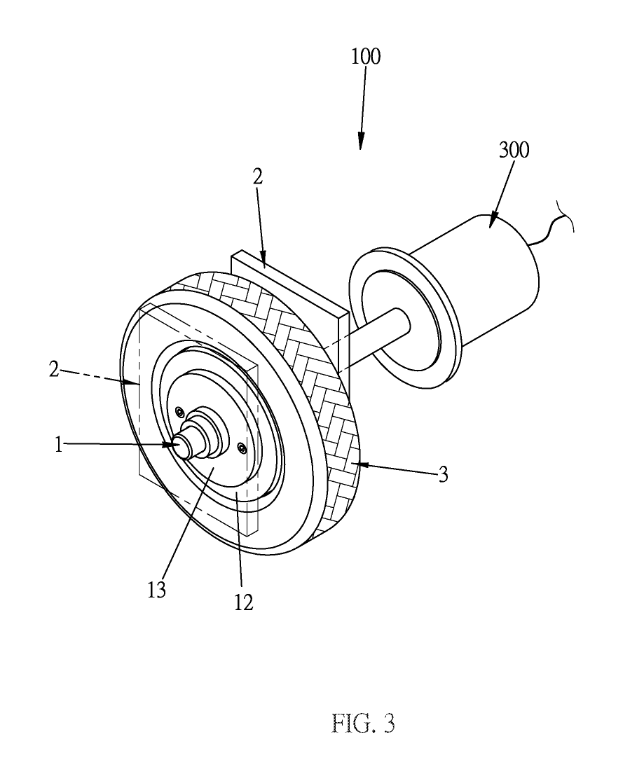

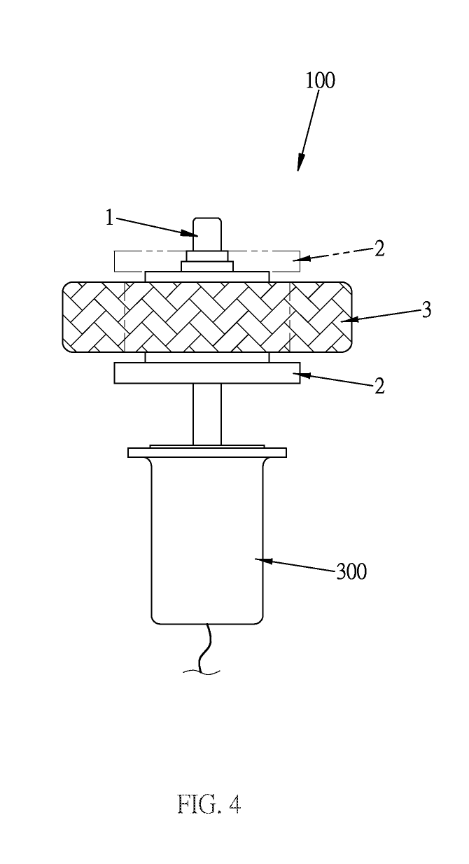

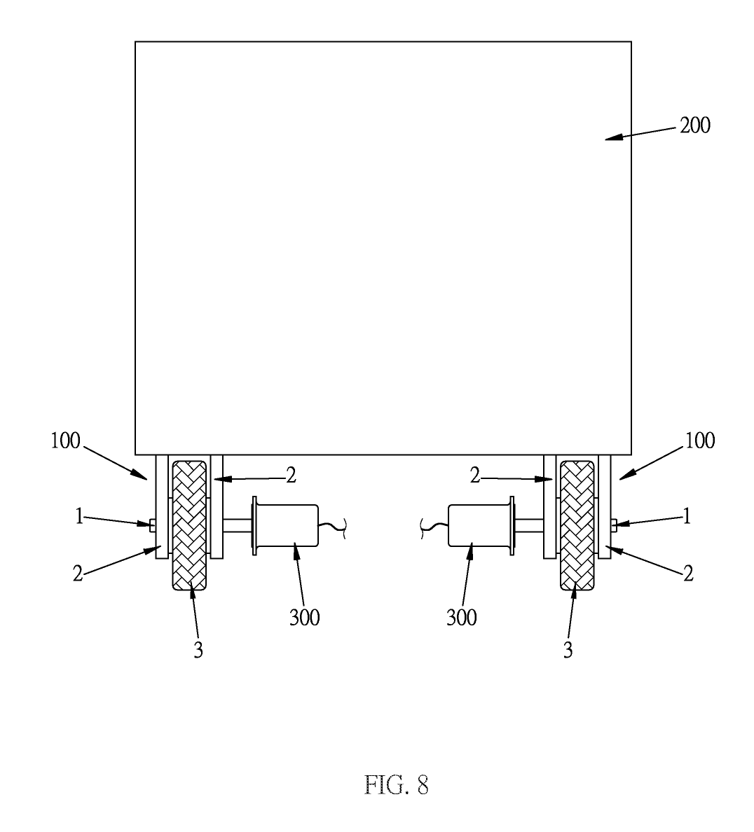

Please refer to FIGS. 2 to 8, an actuating device 100 of the present invention may comprise a speed reducer 1, at least one fixing member 2, and a driven member 3.

The speed reducer 1 may have an input side 11, a rotation portion 12, and an output side 13. The input side 11 and the output side 13 are respectively arranged at two sides of the rotation portion 12 in an axial direction thereof. A diameter of the rotation portion 12 is larger than a diameter of the input side 11 and a diameter of the output side 12. That is, an outer surface of the rotation portion 12 is protruded from the input side 11 and output side 13.

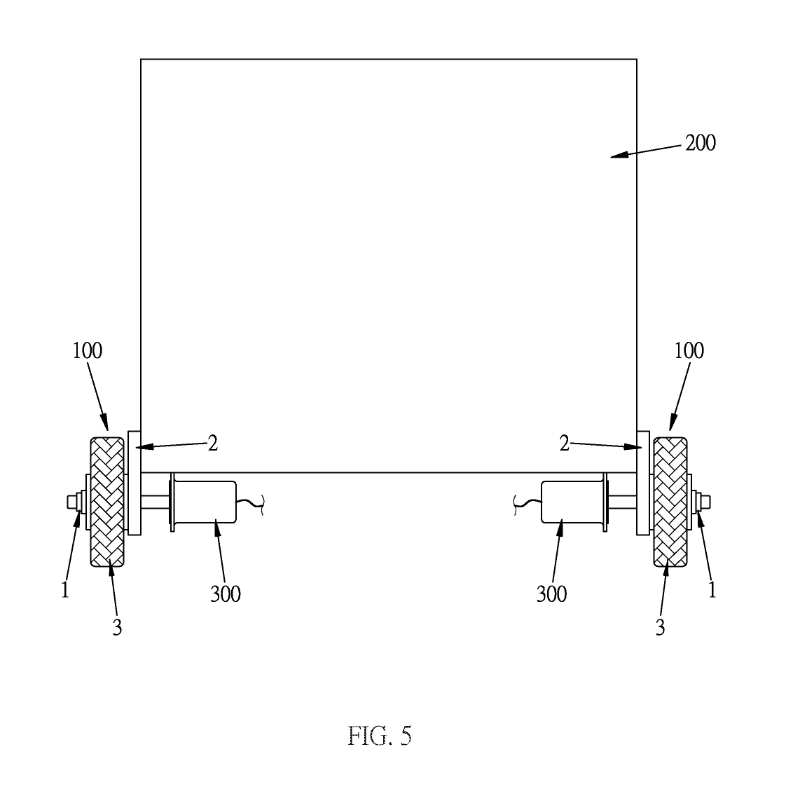

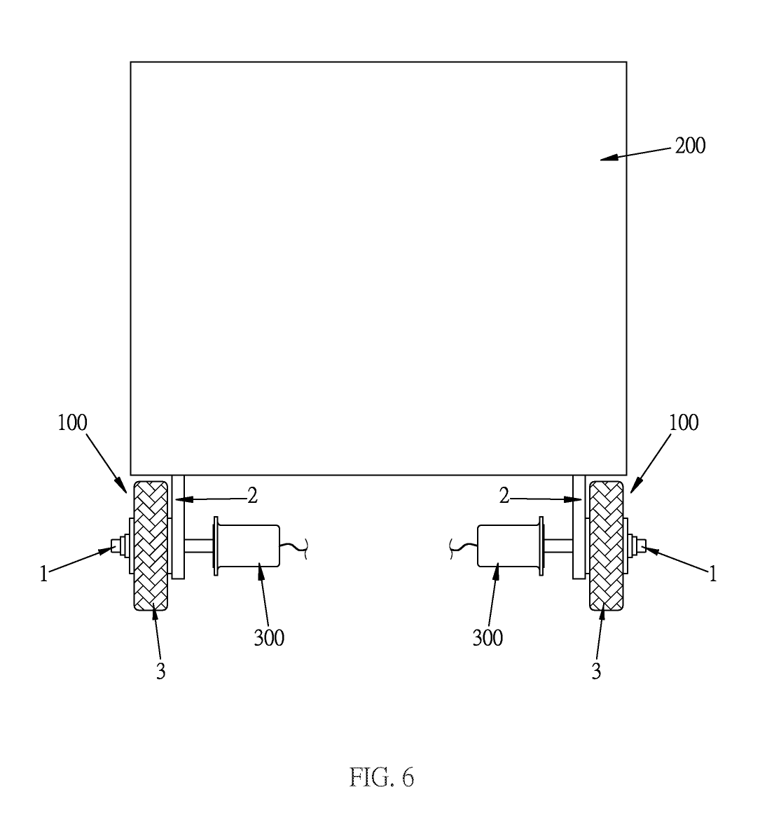

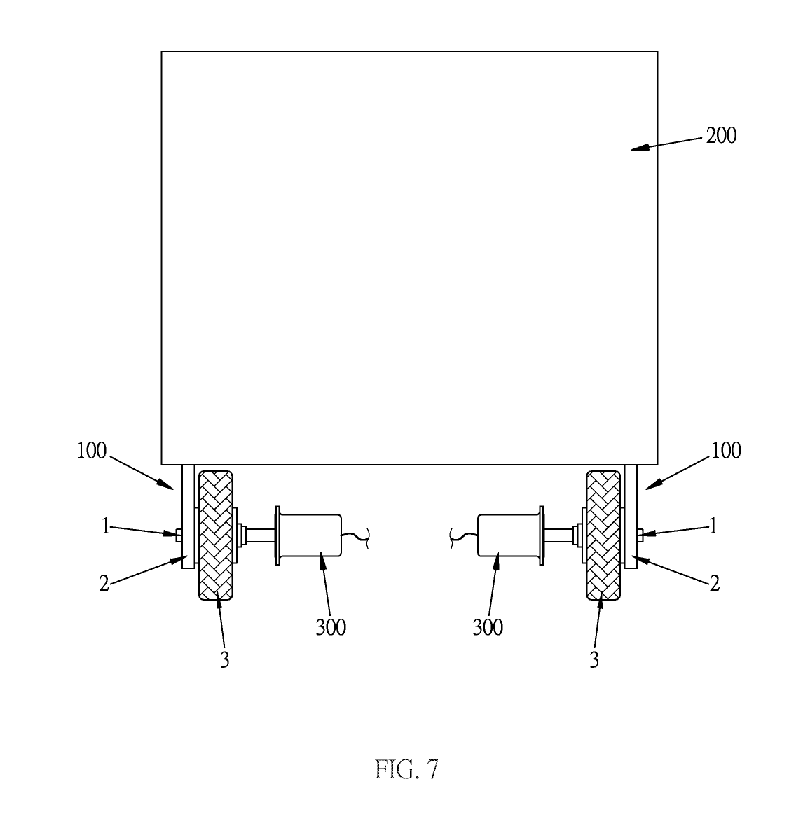

The number of the fixing member 2 may be single one or two. The fixing member 2 may be arranged at a bottom portion of an automatic guided vehicle 200. If the number of the fixing member 2 is single one, the fixing member 2 may be arranged at an outer side of a bottom end of the automatic guided vehicle (shown in FIG. 5), or the fixing member 2 may be arranged at a support plate extended from the bottom end of the automatic guided vehicle 200 (shown in FIGS. 6 and 7).

The input side 11 of the speed reducer 1 may be fixed at the fixing member 2 (shown n FIG. 6), or the output side 13 of the speed reducer 1 may be fixed at the fixing member 2 (shown in FIG. 7).

The driven member 3 (a tire for illustration) may cover outside of the rotation portion 12.

In addition, the driven member 3 may be a gear or belt pulley. It may be cooperated with a conveyor belt for transmission.

In general, the input side 11 of the speed reducer 1 may be driven by a motor 30 to rotate so that the planet gear or rollers may be decelerated to reduce the speed of the output side 13 and enhance the output torque. For example, if the ratio of the speed of the output side 13 to the speed of the input side 11 is 1/10, the torque of the output side 13 is ten times of the torque of the input side 11, so on and so forth.

Since the input side 11 and/or the output side 13 of the speed reducer 1 is not rotated by being fixed at the fixing member 2, the power of the motor 300 may be transmitted to the rotation portion 12 to rotate. And since the driven member 3 (tire) is covered outside of the rotation portion 12, the actuating device 100 may be functioned as a driving wheel.

Compared to the prior art, the driven member 3 (tire) is covered outside of the rotation portion 12 of the speed reducer 1 so that the width of the actuating device 100 becomes thinner and the volume of the actuating device 100 becomes small to make it install to a targeting object (automatic guided vehicle 200) much easier. If the volume of the targeting object is smaller, the actuating device 100 may be easily installed or assembled to match the available space and make the use of the actuating device 100 much broader.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. An actuating device, comprising:
a speed reducer, having an input side, a rotation portion, and an output side, the input side and the output side are respectively arranged at two sides of the rotation portion in an axial direction thereof;
a fixing member, the input side or the output side of the speed reducer is fixed at the fixing member; and
a driven member, covered an outer peripheral of the rotation portion.

2. The actuating device as claimed in claim 1, wherein the driven member is a tire.

3. The actuating device as claimed in claim 1, wherein the speed reducer is rotated with a motor for controlling the rotation portion of the speed reducer to rotate.

4. The actuating device as claimed in claim 1, wherein the fixing member is arranged at a bottom portion of an automatic guided vehicle.

5. The actuating device as claimed in claim 1, wherein a diameter of the rotation portion is larger than a diameter of the input side and a diameter of the output side.

6. The actuating device as claimed in claim 1, wherein the driven member cooperates with a conveyor belt for transmission.

7. An actuating device, comprising:
a speed reducer, having an input side, a rotation portion, and an output side, the input side and the output side are respectively arranged at two sides of the rotation portion in an axial direction thereof, a diameter of the rotation portion is larger than a diameter of the input side and a diameter of the output side;
two fixing members, spaced apart from each other, the input side and the output side of the speed reducer are respectively fixed at the two fixing members; and
a driven member, covered an outer peripheral of the rotation portion.

8. The actuating device as claimed in claim 7, wherein the driven member is a tire.

9. The actuating device as claimed in claim 7, wherein the speed reducer is rotated with a motor for controlling the rotation portion of the speed reducer to rotate.

10. The actuating device as claimed in claim 7, wherein the fixing member is arranged at a bottom portion of an automatic guided vehicle.
